(19) United States
(12) Patent Application Publication
(10) Pub. No.: US 2014/0214616 A1
(43) Pub. Date: Jul. 31, 2014

(54) Active Catalog

(71) Applicant: CATALOG DATA SOLUTIIONS, San Jose, CA (US)

(72) Inventors: John Cameron Major, San Jose, CA (US); David Henry Begin, JR., San Jose, CA (US); Aaron Martin Smith, San Jose, CA (US); Richard Duane Bjorn, San Jose, CA (US)

(73) Assignee: Catalog Data Solutiions, San Jose, CA (US)

(21) Appl. No.: 13/750,951

(22) Filed: Jan. 25, 2013

(51) Int. Cl. G06Q 30/06

(52) U.S. Cl. CPC G06Q 30/0623
USPC 705/26.61

(57) ABSTRACT

Paper catalog pages can be optically scanned to produce “fingerprints” identifying those pages. Database records for products featured on those pages can be mapped to the pages' fingerprints. Later, a customer's mobile phone's digital camera can photograph a paper catalog page. A software application can determine a fingerprint for that page based on the photograph. The phone can transmit this fingerprint over networks to a server. The server can match the transmitted fingerprint to a fingerprint stored in the database. The server can transmit, back to the phone, information retrieved from the database records that are mapped to the matching fingerprint. For example, the information can pertain to current prices and inventories of products featured on the page. For another example, the information can pertain to updated models of obsolete products featured on the page. The phone can present this current, catalog-external information to a customer that took the photograph.

### BACKGROUND

Aspects of the disclosure relate to computing devices and computer software. In particular, certain embodiments relate to techniques for retrieving and presenting updated information from a database.

Suppliers, such as manufacturers and distributors, have for many years printed voluminous catalogs describing the various parts or other products that they have for sale. These catalogs they distribute to potential customers, such as engineers, specifiers, and buyers. Unfortunately, the content of such catalogs is static and immutable in nature. Very often, the catalog's content can be out-of-date by the time that it is printed; the parts or products listed therein can be, by the time the catalog goes to press, made obsolete by newer, superior parts or products. The larger a paper catalog is, the more it costs to print and to distribute.

Suppliers can attempt to update their catalogs by mailing out replacement pages to the catalog holders. However, most suppliers, for one reason or another, choose not to mail out such replacement pages. Even when suppliers do mail out such replacement pages, the catalog holders often do not update their catalogs with the replacement pages that those catalog holder receive. As a result, potential customers often have years' worth of old catalogs sitting on their bookshelves, with outdated information that is unlikely to be updated by the suppliers of those catalogs. These old catalogs represent a significant financial investment on the part of the suppliers over the years.

In spite of these disadvantages, paper catalogs continue to remain a popular marketing tool. Catalogs are tangible, physical items that salespeople can leave behind with their target customers. Catalogs are things that customers traditionally have opted to keep around. Customers do read catalogs at least some time, even if they are outdated. Because nobody has yet come up with a suitable replacement marketing tool that is so willingly accepted and retained by potential customers, thick, heavy, expensive, dated paper catalogs are not likely to disappear from the scene any time soon.

Unfortunately, in addition to their problems of being fairly immutable and tending to become outdated quickly, paper catalogs also compete poorly with modern information technology in many respects. Modern online databases and enterprise resource planning (ERP) systems are able to keep current information regarding inventories and prices of parts and products. These modern information technology systems are also highly accessible and easily updated. Nevertheless, pure data is not something that a salesman can leave at a potential customer's shop.

### BRIEF SUMMARY

According to techniques disclosed herein, pages of a paper catalog can be mapped to data stored in a database on a computing device. For example, each page of the paper catalog can be optically scanned in order to produce a computer-recognizable “fingerprint” that uniquely identifies that page. Then, for each part or product that is featured on that page, the database record for that part or product can be linked or mapped, in the database, to the fingerprint for that page. Such a database record for a part or product can be periodically updated, from other information sources, with additional information pertaining to that part or product that is not found on the page itself; such additional information can include a current price of the part or product, and/or a quantity of the part or product that is currently in inventory.

After the database has been populated in this manner, a customer desiring further information on a part or product featured on a particular page of the paper catalog can use a digital camera—potentially built into his mobile phone—to take a digital photograph of the particular page. A software application—potentially executing on the mobile phone mentioned—can then apply, to this digital photograph, the same algorithm that was originally applied to the catalog's pages to produce the fingerprints for those pages. As a result, the software application can determine the unique fingerprint for the particular page photographed.

The mobile phone, or other device producing the fingerprint, can then transmit this fingerprint over networks to a server that interfaces with the database that links fingerprints to part and product records. The server can match the transmitted fingerprint to a fingerprint previously stored in the database. Upon locating a matching fingerprint, the server can transmit, back to the mobile phone or other device, information retrieved from the database records that are linked or mapped to the matching fingerprint. For example, the information can pertain to the current prices of parts or products that are featured on the particular page. For another example, the information can pertain to the quantities currently in inventory of parts or products that are featured on the particular page. For yet another example, the information can pertain to updated models of now obsolete parts or products that are featured on the particular page. The mobile phone or other device can present this information to the customer who photographed the catalog page. That customer can then use this current information in order to make a more informed purchasing decision.

### BRIEF DESCRIPTION OF THE DRAWINGS

FIG. 1 is a block diagram that illustrates an example of a system for retrieving database records mapped to paper catalog image data, according to an embodiment of the invention;

FIG. 2 is a flow diagram that illustrates an example of a technique for initially populating a database with information pertaining to items featured in a paper catalog, according to an embodiment of the invention;

FIG. 3 is a flow diagram that illustrates an example of a technique for presenting enhanced information about items on a paper catalog page based on a digital photograph of that catalog page, according to an embodiment of the invention;

FIG. 4 is a flow diagram that illustrates an example of an alternative technique for presenting enhanced information about items on a paper catalog page based on a digital photograph of that catalog page, according to an embodiment of the invention; and

FIG. 5 illustrates an example of a computer system in which various aspects of the disclosure may be implemented.

### DETAILED DESCRIPTION

In the following description, for the purposes of explanation, specific details are set forth in order to provide a thorough understanding of embodiments of the invention. However, it will be apparent that various embodiments may be practiced without these specific details.

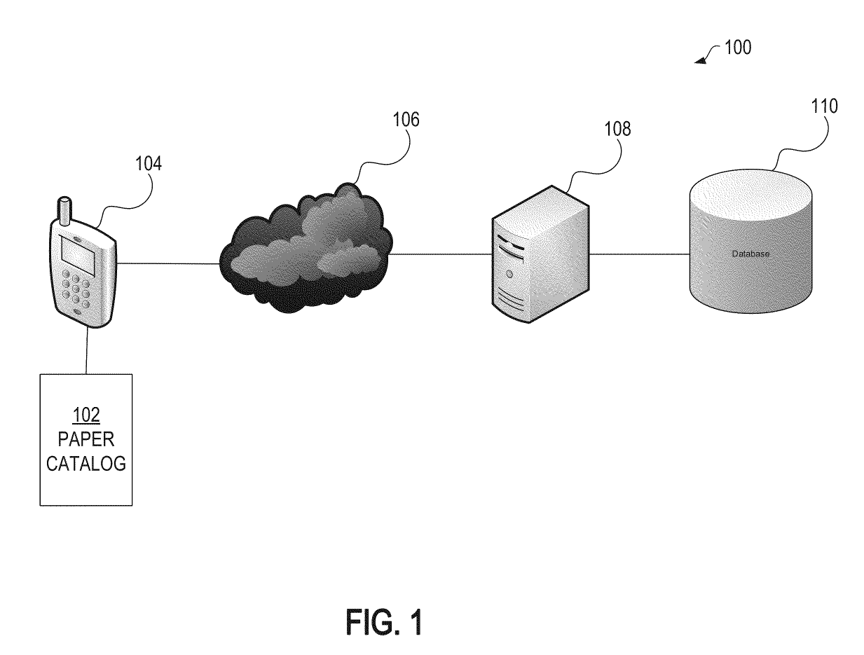

FIG. 1 is a block diagram that illustrates an example of a system 100 for retrieving database records mapped to paper catalog image data, according to an embodiment of the invention. System 100 includes a paper catalog 102, a mobile device 104, the Internet 106, a server 108, and a database 110. In an embodiment of the invention, mobile device 104 can be a cell phone such as a smart phone. Mobile device 104 can possess a digital camera capable of capturing digital image data to be stored within a memory of mobile device 104.

Mobile device 104 also can store a software application that can be applied to such digital image data to produce a unique “fingerprint” for that data. As used herein, a “fingerprint” is a set of data that is derived from other data and that more compactly and uniquely identifies that other data. For example, in one embodiment of the invention, the software application can apply optical character recognition to words and characters represented within the digital image data in order to produce text that serves as a fingerprint for that digital image data. In one embodiment of the invention, the fingerprint can be some portion of, or all of, the digital image data itself. As used herein, fingerprints can assume a variety of different formats. In one embodiment of the invention, the catalog pages are “legacy” catalog pages that do not contain any special codes or symbols that identify the pages, beyond the content that was already on the catalog page. In such an embodiment of the invention, the fingerprints can be generated based solely on text that describes parts or products for sale on the page, and/or images of parts or products for sale on the page. In such an embodiment, the catalog pages can even pre-date the software application, such that those catalog pages can have been created and printed without the software application, or any embodiment of the invention, in mind or in existence at the time of the catalog's creation. Thus, certain embodiments of the invention can work with catalogs that are decades old.

In an embodiment of the invention, mobile device 104 can possess a wireless network communication module that uses a wireless communication network, such as a 3G or 4G cellular network, to transmit data to and receive data from other devices. For example, mobile device 104 can wirelessly transmit data, including a fingerprint or digital image data, over wireless networks and through Internet 106 to server 108. A variety of communication protocols can be used in concert with each other in order to accomplish this network communication; for example, the communication can employ such protocols as Transmission Control Protocol (TCP), User Datagram Protocol (UDP), Internet Protocol (IP), Hypertext Transfer Protocol (HTTP), File Transfer Protocol (FTP), Simple Mail Transfer Protocol (SMTP), Short Message Service (SMS), Wireless Access Protocol (WAP), etc.

In an embodiment of the invention, server 108 can receive fingerprint or digital image data that was transmitted over Internet 106 from mobile device 104. In an embodiment in which mobile device 104 transmits original digital image data rather than a fingerprint (derived from such digital image data) to server 108, server 108 can apply a software application, stored on server 108, to the digital image data in order to derive the fingerprint therefrom. Thus, in alternative embodiments of the invention, the calculation of the fingerprint from the digital image data can be performed by mobile device 104 or server 108.

In either case, server 108 can search database 110 for database records that are associated with the fingerprint. Database 110 can contain data that has been aggregated from various disparate servers and/or other databases that can be hosted by parties other than the party that hosts database 110. Database 110 can be a distributed database. Such database records can contain fields that specify the fingerprint, for example, or such records can otherwise be linked or mapped to the fingerprint. In an embodiment, server 108 can use Structured Query Language (SQL) to query database 110 for database records that match the fingerprint. In alternative embodiment of the invention, server 108 can use other techniques to search database 110 for database records that match the fingerprint. In an embodiment of the invention, the fingerprint matching can, but does not need to, involve finding an exact match; in one embodiment of the invention, server 108 can employ “fuzzy” matching, which can involve machine-learned pattern-matching techniques that are known in the art, to the database records in order to find a best approximate match between the fingerprints in database 110 and the fingerprint that was derived from the digital image data. In one embodiment of the invention, the records in database 110 contain pointers to data that is contained within other databases in a distributed database system. Such other databases can be hosted by various different parties. Thus, database 110 itself does not necessarily need to contain all information that is associated with each fingerprint.

In an embodiment of the invention, database 110 can persistently store database records that map fingerprints to information pertaining to parts or products that are featured on paper catalog pages that correspond to those fingerprints. Such database records can include information that is additional to the information that is found on the paper catalog pages themselves, and such information can be dynamic rather than static in nature. For example, a database record for a particular part can indicate (a) a current price for that part and/or (b) a quantity of that part that is currently available in inventory. A database record for a particular part can even pertain to a different part than the part actually featured on the paper catalog page, if the actually featured part is obsolete; the database record can pertain to a newer part that has replaced the obsolete part, for example. The database records can also include information linking those database records to other database records. For example, a particular database record pertaining to a particular part can contain links to database records pertaining to other parts that customers have frequently viewed and/or frequently purchased after viewing and/or purchasing the particular part.

In an embodiment of the invention, database 110 can be populated initially by technicians that use electronic scanning devices to electronically scan pages of paper catalog 102 to produce digital image data for those pages. These technicians can then apply the software application discussed above to the digital image data for each page to produce the fingerprint for that page. The technicians can create a separate database record for each part or product featured on that page, and map that database record to the fingerprint for that page (as mentioned above, the fingerprint can be included within a field of the record itself). The technicians can enter, into the database record for a particular part or product, various information pertaining to that part or product, such as physical dimensions, physical properties, weights, materials from which the part or product is composed, an identity of the part's or product's manufacturer, part or product identifier, performance information, etc.

The technicians can also enter, into such a database record, information pertaining to the identity of the catalog (e.g., supplier, date, etc.) and/or page on which the part is featured; in an embodiment, database 110 can contain database records pertaining to parts and products from a multitude of different catalogs, potentially from different suppliers. The database record can include data representing a separate image of the part or product itself, isolated from other parts or products featured on the same page. The database record can include descriptive text pertaining to the part or product that is printed on the catalog page in association with the part or product.

In an embodiment of the invention, the technicians can create a three-dimensional computer-aided drafting (CAD) model of the physical product or part, and include data representing that CAD model, or a link to such data, within the database record that pertains to that part or product. Thus, database 110 can be populated with database records for parts and products, and these database records can associate those parts and products with fingerprints that uniquely identify the paper catalog pages that feature those parts and products (or obsolete predecessors thereof).

In an embodiment of the invention, database 110 is coupled with an ERP system. Through this coupling, current data can be maintained for each database record regarding a current price for the part or product to which that record pertains, and/or a quantity of that part or product that is currently available in inventory. Such ERP-based data can be updated periodically to maintain the data's freshness.

As is discussed above, server 108 can match (a) the fingerprint derived from the paper catalog page digitally photographed by mobile device 104 to (b) records that are mapped (exactly or approximately) to that fingerprint in database 110. In an embodiment, server 108 can transmit, over Internet 106 and wireless networks, to mobile device 104, information retrieved from these records. Such information can pertain to parts and products that are featured on the paper catalog page that mobile device 104 digitally photographed. Mobile device 104 can present, to its user, a list of the parts and products that are featured on the catalog page. The user can select a particular item from this list. Mobile device 104 can then present, to the user, more detailed information regarding the particular item.

For example, in one embodiment, mobile device 104 can present an interactive three-dimensional CAD model of the particular item on its display; software executing on mobile device 104 can enable the user to rotate, zoom-in on, and zoom-out from the view of the model, so that the user can obtain a more thorough concept of the particular item. For another example, in one embodiment, mobile device 104 can present dynamic information that was retrieved from an ERP system, such as the current price of the particular item, the quantity of the particular item that is currently available in inventory, the identities of other items that are frequently viewed and/or purchased by people who view and/or purchase the particular item, etc. For another example, in one embodiment, mobile device 104 can present up-to-date reviews of the particular item submitted to server 108 by various different users; such reviews can be stored in database 110 or in separate databases to which the records in database 110 can refer. Significantly, such dynamic information can be current as of the time of that mobile device 104 photographed the paper catalog page. For another example, if the particular item is obsolete or no longer available, mobile device 104 can present information that identifies other currently available items that are suitable replacements for the particular item. In one embodiment, mobile device 104 can present a timeline that shows the particular item, and the dates at which it was available, as well as one or more replacements for the particular item, and the dates at which those replacements were available. Such a timeline can illustrate multiple generations or revisions of an obsolete item, and can indicate the changes that have been made to the item in each generation or revision.

For another example, based at least in part on location information that the user of mobile device 104 has supplied to mobile device 104, mobile device 104 can present information that indicates how much it will cost to ship the particular item from its particular location to the user's indicated location. In an embodiment, the user's current location can be dynamically and automatically determined by mobile device 104 using a global positioning system of mobile device 104, or estimated based on an identity of (e.g., an IP address of) a wireless access point through which mobile device 104 is currently communicating through Internet 106. In one embodiment of the invention, a software application executing on mobile device 104 enables the user to submit a purchase order for, and provide payment information for, a selected quantity of the particular item. Such a software application can sent the purchase order and shipping information over wireless networks and Internet 106 to the particular item's seller for fulfillment. Inasmuch as the database records in database 110 can represent parts and products from a multitude of different sellers, in one embodiment, the software application can use the seller's identity as indicated in the database record for the particular item in order to determine where to send the purchase order and payment and shipping information. In an embodiment of the invention, each database record in database 110 identifies both a seller of the item to which that record pertains and a uniform resource locator (URL) for an order-receiving server that the seller maintains; the software application executing on mobile device 104 can send the purchase order, payment, and shipping information over Internet 106 to this URL.

In an embodiment of the invention, server 108 stores, in database 110, information pertaining to the histories of interactions of users with the records stored therein. For example, database 110 can indicate an identity of each user that viewed a particular record's information and/or each user that purchased an item specified by a particular record. Database 110 can indicate a price that was paid for such an item by each user; some users can pay more than other users. In one embodiment of the invention, server 108 can dynamically determine price information based on both (a) a base price for an item, as indicated in that item's database record, and (b) an identity and role of the user that has sent the fingerprint for the page featuring that item. For example, server 108 can select a higher price for a user that is known to be a buyer, but a lower price for a user that is known to be an engineer. For another example, server 108 can select a higher price for a user that is known to belong to a large corporation, but a lower price for a user who is known to be acting as a sole individual. In an embodiment of the invention, server 108 can update database 110 to indicate, for each particular item that is viewed or purchased, other related items that the same user also viewed or purchased; this updating can be based upon the user's identity and/or upon an identity of the communication session established between mobile device 104 and server 108.

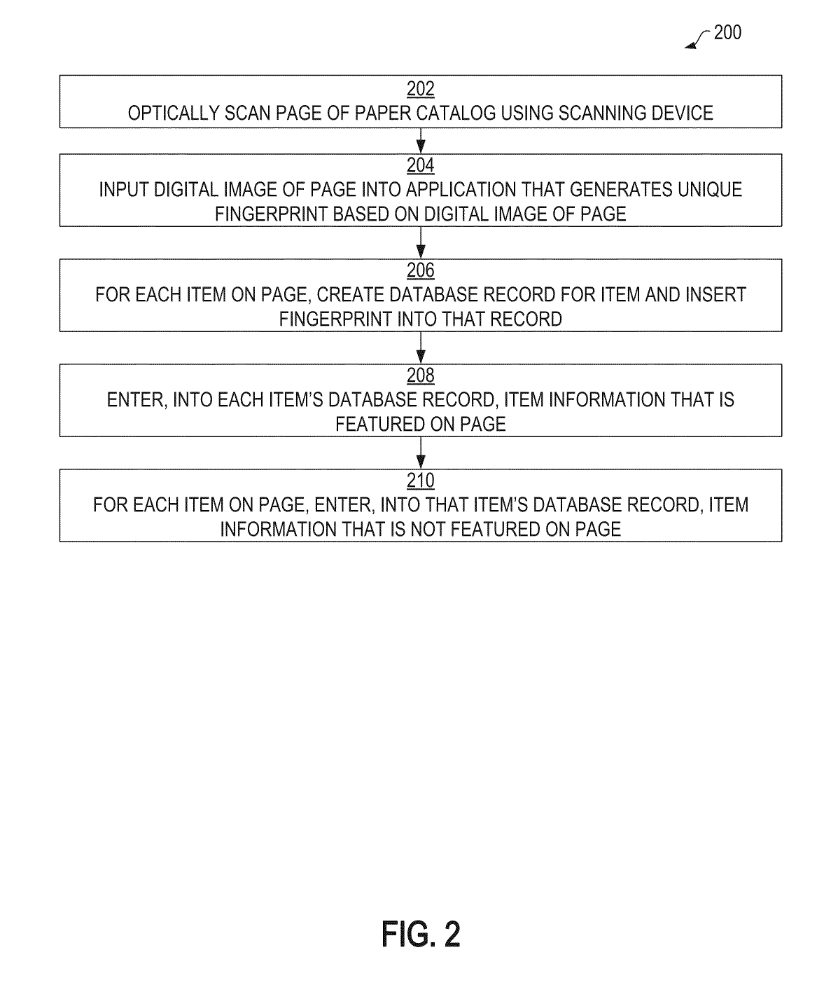

FIG. 2 is a flow diagram that illustrates an example of a technique 200 for initially populating a database with information pertaining to items featured in a paper catalog, according to an embodiment of the invention. Although technique 200 includes operations being performed in a particular order, alternative embodiments of the invention may involve similar operations being performed in a different order. Alternative embodiments of the invention may involve additional, fewer, or some different operations that those illustrated in connection with technique 200. In block 202, a technician can optically scan a page of a paper catalog using an electronic scanning device, thereby producing a digital image of that page. In block 204, the technician can input the digital image into a software application that generates a unique fingerprint based on the digital image, such that no two digital images of different catalog pages have the same fingerprint. In block 206, for each item featured on the page, the technician can create a database record for that item in a database and inserts the fingerprint into that item's database record. In block 208, the technician can enter, into each item's database record, information pertaining to that item as featured on the page. For example, such information may include a name of the item, a manufacturer of the item, a product identifier for the item, physical specifications of the item, a textual description of the item, an identity of the catalog and page number of the page on which the item is featured, etc. In block 210, the technician can enter, into each item's database record, information pertaining to that item that is not featured on the page. Such catalog-external information can include links to ERP data for the item and/or CAD model data for the item, for example.

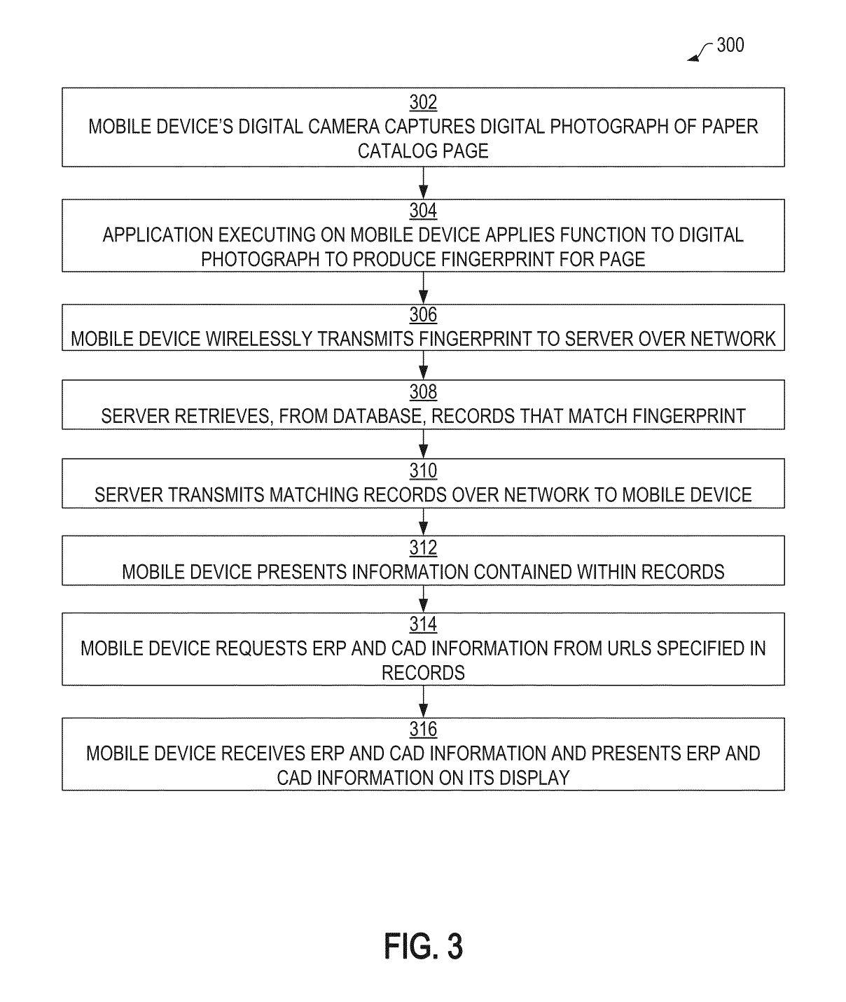

FIG. 3 is a flow diagram that illustrates an example of a technique 300 for presenting enhanced information about items on a paper catalog page based on a digital photograph of that catalog page, according to an embodiment of the invention. Although technique 300 includes operations being performed in a particular order, alternative embodiments of the invention may involve similar operations being performed in a different order. Alternative embodiments of the invention may involve additional, fewer, or some different operations that those illustrated in connection with technique 300. In block 302, a mobile device's digital camera can capture a digital photograph of a page of a paper catalog. In block 304, a software application executing on the mobile device can apply a function to the digital photograph data to produce a fingerprint that uniquely identifies the page. As is discussed above, in one embodiment, the fingerprint can be a portion of the digital photograph or the entire photograph. In one embodiment, the fingerprint can include text that was produced as a consequence of applying OCR techniques to words appearing within the digital photograph. In one embodiment, the fingerprint can be data produced as a result of algorithmically identifying distinctive points of reference within the digital photograph, as is sometimes performed relative to actual human fingerprints. In block 306, the mobile device can wirelessly transmit the fingerprint over networks to a server. In block 308, in response to receiving the fingerprint, the server can retrieve, from a database (or multiple databases in a distributed database system), records that match (exactly or approximately) the fingerprint. Such a database or distributed database system can be populated with such records using technique 200 discussed above in connection with FIG. 2, for example. In block 310, the server can transmit the records back over the networks to the mobile device. In block 312, in response to receiving the matching records, the mobile device can present, on its display, information contained within the matching records. The information can include data pertaining to items that are featured on the paper catalog page. In block 314, the mobile device can request ERP and CAD information from URLs that are specified in the matching records. In block 316, the mobile device can receive the requested ERP and CAD information wirelessly from various sources and present the ERP and CAD information on its display. Thus, in one embodiment, the ERP and CAD information is not requested by the server and then related to the mobile device, but instead is requested directly (from sources storing the information) by the mobile device using URLs or other links or pointers that the server returned to the mobile device. However, in an alternative embodiment of the invention, the server can store such ERP and CAD information in a database system—potentially aggregated previously from the sources of that information—and return such ERP and CAD information from the matching records themselves to the mobile device without further involvement with those sources.

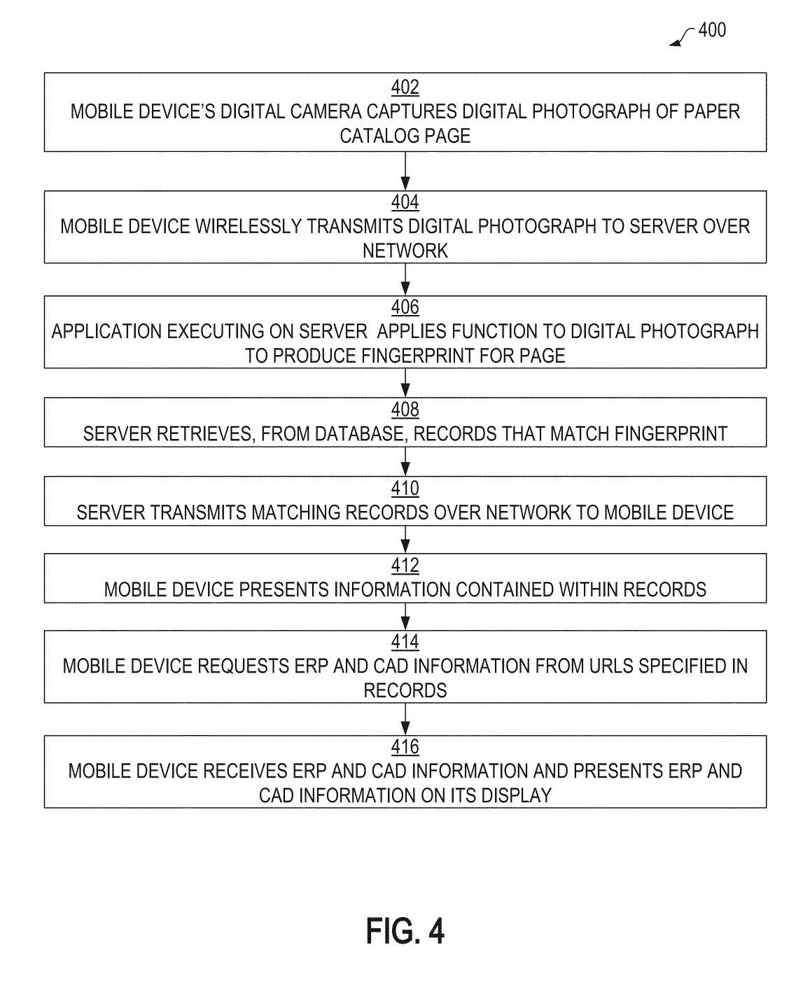

Although an embodiment discussed above in connection with FIG. 3 can involve the fingerprint for the catalog page being generated by a mobile device, alternative embodiments of the invention can involve the fingerprint being generated by the server instead. FIG. 4 is a flow diagram that illustrates an example of an alternative technique 400 for presenting enhanced information about items on a paper catalog page based on a digital photograph of that catalog page, according to an embodiment of the invention. Although technique 400 includes operations being performed in a particular order, alternative embodiments of the invention may involve similar operations being performed in a different order. Alternative embodiments of the invention may involve additional, fewer, or some different operations that those illustrated in connection with technique 400. In block 402, a mobile device's digital camera can capture a digital photograph of a page of a paper catalog. In block 404, the mobile device can wirelessly transmit the fingerprint over networks to a server. In block 406, in response to receiving the fingerprint, a software application executing on the server can apply a function to the digital photograph data to produce a fingerprint that uniquely identifies the page. As is discussed above, in one embodiment, the fingerprint can be a portion of the digital photograph or the entire photograph. In one embodiment, the fingerprint can include text that was produced as a consequence of applying OCR techniques to words appearing within the digital photograph. In one embodiment, the fingerprint can be data produced as a result of algorithmically identifying distinctive points of reference within the digital photograph, as is sometimes performed relative to actual human fingerprints. In block 408, the server can retrieve, from a database (or multiple databases in a distributed database system), records that match (exactly or approximately) the fingerprint. Such a database or distributed database system can be populated with such records using technique 200 discussed above in connection with FIG. 2, for example. In block 410, the server can transmit the records back over the networks to the mobile device. In block 412, in response to receiving the matching records, the mobile device can present, on its display, information contained within the matching records. The information can include data pertaining to items that are featured on the paper catalog page. In block 414, the mobile device can request ERP and CAD information from URLs that are specified in the matching records. In block 416, the mobile device can receive the requested ERP and CAD information wirelessly from various sources and present the ERP and CAD information on its display. As is discussed above, in an embodiment of the invention, the server can store such ERP and CAD information in a database system—potentially aggregated previously from the sources of that information—and return such ERP and CAD information from the matching records themselves to the mobile device without further involvement with those sources from which that information was previously aggregated.

Although embodiments of the invention above can involve a mobile device's digital camera taking a digital photograph of a paper catalog page, and a page-identifying fingerprint being generated based on the digital photograph data, in alternative embodiments of the invention, the fingerprint can be generated based on alternative information. For example, in an alternative embodiment of the invention, the fingerprint can be generated based upon a digital photograph of a mere portion of the paper catalog page rather than the entire page; in such an embodiment, the records in database 110 can be referenced by fingerprints for page portions rather than for entire pages. More specifically, each fingerprint can correspond to an item on a page rather than the entire page. For another example, in an alternative embodiment of the invention, the fingerprint can be generated based on textual information entered by the mobile device's user. The fingerprint can even be such textual information itself. More specifically, in one alternative embodiment, the fingerprint can be, or can include, an alphanumeric string that uniquely identifies the paper catalog (e.g., an ISBN or barcode number) concatenated with a page number. In an embodiment of the invention, the fingerprint can be generated based on information that does not involve or include a Quick Response (QR) code. Furthermore, although in one embodiment of the invention the digital photograph data can be generated by a digital camera of a mobile device, in alternative embodiments of the invention, such digital photograph data can be generated by an optical scanning device, such as for example, those that can be found in copying, scanning, and facsimile machines.

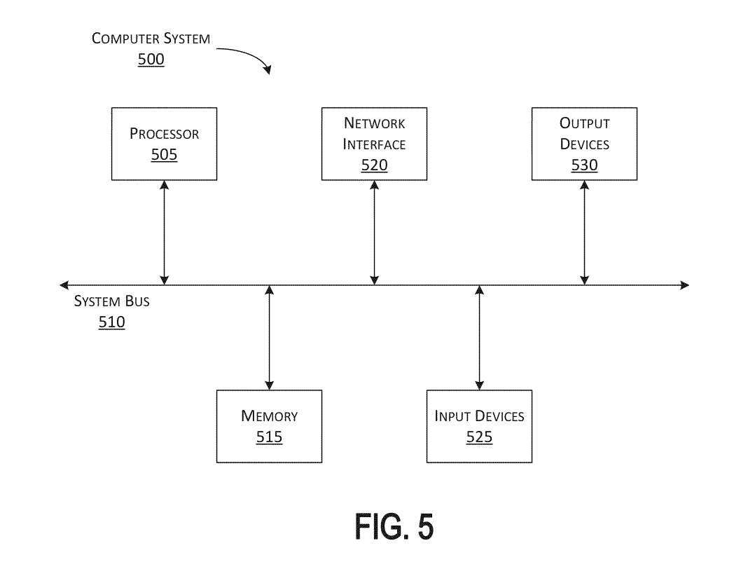

FIG. 5 illustrates an example of a computer system 500 in which various aspects of the disclosure may be implemented. The various computers and servers illustrated in the previously described figures, such as mobile device 104 and server 108, may implement any and/or all of the components of computer system 500 depicted in FIG. 5. In some arrangements, these computers and servers further may include other components in addition to and/or instead of those seen in computer system 500.

As seen in FIG. 5, the computer system 500 may include a processor 505, which may be interconnected to other components of the computer system 500 via system bus 510. This interconnection may enable processor 505 to execute instructions stored in memory 515, for example, and control other components of the computer system 500, such as network interface 520, one or more input devices 525, and one or more output devices 530. Network interface 520 may facilitate communication with other computer systems, and may include wired network interfaces, such as an Ethernet interface, and/or wireless network interfaces, such as an IEEE 802.11 interface. Input devices 525 may include peripheral devices, such as one or more keyboards, mice, microphones and/or the like, and output devices 530 may include various output subsystems, such as one or more displays, speakers, and/or the like. Other components may be similarly coupled to and/or otherwise implemented in computer system 500.

Although the invention has been described with respect to specific embodiments, it will be appreciated that the invention is intended to cover all modifications and equivalents within the scope of the following claims. Any and/or all of the techniques, methods, and/or method steps discussed above can implemented in software (e.g., programs, code, instructions, etc.), hardware, or combinations thereof. The software may be stored on a non-transitory storage medium (e.g., the memory discussed above), and, when executed by one or more processors, may cause a computer system to perform one or more of the techniques, methods, and/or method steps. Additionally or alternatively, in some embodiments, any and/or all of the software may leverage a Software as a Service (SaaS) model, in which one or more methods and/or method steps are executed and/or otherwise performed in the cloud (e.g., at a web server) in order to provide various functionality to a remote end user (e.g., at the user's web browser).

The entire content of U.S. Provisional Patent Application No. 61/623,227, titled “USING CROSS-DOMAIN COMMUNICATION TO SERVE CLOUD-BASED PRODUCT CATALOG PAGES FROM A SELLER′S DOMAIN,” is incorporated by reference herein.

What is claimed is:

1. A computer-implemented method comprising:
based on at least in part on fingerprint data that was derived from a digital photograph of a page of a paper catalog, selecting, from among a plurality of database records, a set of records that are mapped to the fingerprint data and that contain information pertaining to items that are featured on the page; and
transmitting the information over one or more networks to a mobile device that captured the digital photograph from the page of the paper catalog.

2. The method of claim 1, further comprising:
based at least in part on the information, retrieving, from one or more information sources, one or more prices that are for at least one of the items and that are current as of a time of the retrieving; and
transmitting the one or more prices over one or more networks to the mobile device.

3. The method of claim 1, further comprising:
based at least in part on the information, retrieving, from one or more information sources, one or more computer-aided design (CAD) models for at least one of the items; and
transmitting the one or more CAD models over one or more networks to the mobile device.

4. The method of claim 1, further comprising:
based at least in part on the information, retrieving, from one or more information sources, a quantity in inventory of at least one of the items, said quantity being current as of a time of the retrieving; and
transmitting the quantity over one or more networks to the mobile device.

5. The method of claim 1, further comprising:
receiving, over one or more networks from the mobile device, data representing the digital photograph; and
generating the fingerprint data at least in part by applying optical character recognition to the data representing the digital photograph.

6. The method of claim 1, further comprising:
receiving the fingerprint data over one or more networks from the mobile device, which generated the fingerprint data at least in part by applying optical character recognition to data representing the digital photograph.

7. The method of claim 1, wherein the information pertaining to the items that are featured on the page includes an identity of a new part that is not featured on the page and that has replaced an obsolete part that is featured on the page.

8. A computer-readable memory storing instructions that are executable to cause one or more processors to perform operations, said instructions comprising:
instructions for selecting, from among a plurality of database records, and based on at least in part on fingerprint data that was derived from a digital photograph of a page of a paper catalog, a set of records that are mapped to the fingerprint data and that contain information pertaining to items that are featured on the page; and
instructions for transmitting the information over one or more networks to a mobile device that captured the digital photograph from the page of the paper catalog.

9. The computer-readable memory of claim 8, said instructions further comprising:
instructions for retrieving, from one or more information sources, and based at least in part on the information, one or more prices that are for at least one of the items and that are current as of a time of the retrieving; and
instructions for transmitting the one or more prices over one or more networks to the mobile device.

10. The computer-readable memory of claim 8, said instructions further comprising:
instructions for retrieving, from one or more information sources, and based at least in part on the information, one or more computer-aided design (CAD) models for at least one of the items; and
instructions for transmitting the one or more CAD models over one or more networks to the mobile device.

11. The computer-readable memory of claim 8, said instructions further comprising:
instructions for retrieving, from one or more information sources, and based at least in part on the information, a quantity in inventory of at least one of the items, said quantity being current as of a time of the retrieving; and
instructions for transmitting the quantity over one or more networks to the mobile device.

12. The computer-readable memory of claim 8, said instructions further comprising:
instructions for receiving, over one or more networks from the mobile device, data representing the digital photograph; and
instructions for generating the fingerprint data at least in part by applying optical character recognition to the data representing the digital photograph.

13. The computer-readable memory of claim 8, said instructions further comprising:
instructions for receiving the fingerprint data over one or more networks from the mobile device, which generated the fingerprint data at least in part by applying optical character recognition to data representing the digital photograph.

14. The computer-readable memory of claim 8, wherein the information pertaining to the items that are featured on the page includes an identity of a new part that is not featured on the page and that has replaced an obsolete part that is featured on the page.

15. A server comprising:
a processor;
a network interface; and
a data storage device that stores instructions which configure the processor to:
selecting, from among a plurality of database records, and based on at least in part on fingerprint data that was derived from a digital photograph of a page of a paper catalog, a set of records that are mapped to the fingerprint data and that contain information pertaining to items that are featured on the page; and
transmit the information over one or more networks to a mobile device that captured the digital photograph from the page of the paper catalog.

16. The server of claim 15, wherein the instructions configure the processor to:
retrieve, based at least in part on the information, and from one or more information sources, one or more prices that are for at least one of the items and that are current as of a time of the retrieving; and
transmit the one or more prices over one or more networks to the mobile device.

17. The server of claim 15, wherein the instructions configure the processor to:
retrieve, based at least in part on the information, and from one or more information sources, one or more computer-aided design (CAD) models for at least one of the items; and
transmit the one or more CAD models over one or more networks to the mobile device.

18. The server of claim 15, wherein the instructions configure the processor to:
retrieve, based at least in part on the information, and from one or more information sources, a quantity in inventory of at least one of the items, said quantity being current as of a time of the retrieving; and
transmit the quantity over one or more networks to the mobile device.

19. The server of claim 15, wherein the instructions configure the processor to:
receive the fingerprint data over one or more networks from the mobile device, which generated the fingerprint data at least in part by applying optical character recognition to data representing the digital photograph.

20. The server of claim 15, wherein the information pertaining to the items that are featured on the page includes an identity of a new part that is not featured on the page and that has replaced an obsolete part that is featured on the page.
